(19) United States
(12) Patent Application Publication
(10) Pub. No.: US 2010/0231680 A1
(43) Pub. Date: Sep. 16, 2010

(54) THERMAL HEAD

(75) Inventors: Tsuneyuki Sasaki, Fukushima-ken (JP); Hirotoshi Terao, Fukushima-ken (JP); Hisashi Hoshino, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD., Tokyo (JP)

(21) Appl. No.: 12/716,779

(22) Filed: Mar. 3, 2010

(30) Foreign Application Priority Data
Mar. 16, 2009 (JP) 2009-063213

(51) Int. Cl. B41J 2/335

(52) U.S. Cl. 347/206

(57) ABSTRACT

A thermal head includes: a head substrate including a plurality of heating elements arranged in a row; and a heat dissipation member supporting the head substrate, wherein heat from the heating elements is transferred to the heat dissipation member through the head substrate, a surface of the heat dissipation member opposing the head substrate is provided with a heat accumulation adjusting groove which has a recessed shape along the arrangement direction of the row of the heating elements, and both edge portions of the surface of the heat dissipation member in a width direction of the heat accumulation adjusting groove come in contact with a rear surface of the head substrate opposing the heat dissipation member, the width direction being perpendicular to the arrangement direction of the heating elements.

### CROSS REFERENCE TO RELATED APPLICATIONS

The present application contains subject matter related to and claims priority to Japanese Patent Application No. 2009-063213 filed in the Japanese Patent Office on Mar. 16, 2009, the entire contents of which are incorporated herein by reference.

### BACKGROUND OF THE DISCLOSURE

1. Technical Field

The present disclosure relates to a thermal head in which a head substrate provided with heating elements is mounted to a heat dissipation member.

2. Related Art

In the past, from the standpoint that an improvement in the recording quality of a printer using a thermal head is achieved by properly dissipating heat of heating elements heated when the thermal head is driven, a thermal head having a heat dissipation member for dissipating the heat of the heating elements has been used.

For example, in a thermal head disclosed in Japanese Unexamined Utility Model Registration Application Publication No. 4-126857, heating elements are arranged and mounted to a supporting member made of metal in parallel in a longitudinal direction of the supporting member. The supporting member is configured as a hollow member having a cavity therein extending in the longitudinal direction of the supporting member, and the cavity is open to both end surfaces of the supporting member. In the thermal head disclosed in Japanese Unexamined Utility Model Registration Application Publication No. 4-126857, since the cavity is formed in the supporting member as described above, it is possible to achieve a reduction in weight and an improvement in the heat dissipation of the supporting member.

In a thermal head disclosed in Japanese Unexamined Patent Application Publication No. 9-156146, a head substrate in which heating elements and a temperature sensor for detecting the temperature of the heating element are disposed is mounted on a heat dissipation member with an adhesive layer interposed therebetween, and a heat transfer performance adjusting space is provided at a position corresponding to the mounting position of the temperature sensor on a rear surface side of the head substrate in the heat dissipation member. In the thermal head disclosed in Japanese Unexamined Patent Application Publication No. 9-156146, by interposing air in the heat transfer performance adjusting space to make the air to function as an insulating material, or by enhancing the heat transfer performance of the heat transfer performance adjusting space, it is possible to change detection responsiveness to a temperature variation of the heating element and heat dissipation characteristics of the heat dissipation member.

However, for example, in the thermal head disclosed in Japanese Unexamined Utility Model Registration Application Publication No. 4-126857, the heating elements are mounted to a main wall of the supporting member, and the main wall of the supporting member is interposed between the heating element and the cavity of the supporting member, so that heat of the heating elements is transferred to the main wall before it is dissipated in the cavity of the supporting member. Therefore, there is a concern that the heat from the heating elements is excessively dissipated.

In the thermal head disclosed in Japanese Unexamined Patent Application Publication No. 9-156146, the heat transfer performance adjusting space is provided at the position corresponding to the mounting position of the temperature sensor, and the head substrate provided with the heating elements is mounted to the heat dissipation member, so that heat from the heating elements is transferred to the heat dissipation member before it is insulated by the heat transfer performance adjusting space. As a result, there is a concern that the heat from the heating elements is excessively dissipated. In addition, in the thermal head disclosed in Japanese Unexamined Patent Application Publication No. 9-156146, the heat transfer performance adjusting space is formed by notching one side edge of a surface opposing the head substrate in the heat dissipation member, and the head substrate is cantilevered by the heat dissipation member. Here, in the thermal head, the heating elements come in pressing contact with a platen to perform recording, and here, pressure is applied to the head substrate provided with the heating elements. However, since the head substrate is cantilevered by the heat dissipation member, joint strength between the head substrate and the heat dissipation member is low, and accordingly, as pressure is applied to the head substrate during recording, there is a problem in that the head substrate and the heat dissipation member may be separated from each other.

These and other drawbacks exits.

### SUMMARY OF THE DISCLOSURE

Examples disclosed herein provide a thermal head capable of properly dissipating heat from each heating element to a heat dissipation member and preventing excessive heat dissipation, thereby achieving improvements in the heat dissipation characteristics and a power saving effect and stably supporting a head substrate provided with the heating elements by the heat dissipation member.

According to an example, there is provided a thermal head including: a head substrate including a plurality of heating elements arranged in a row; and a heat dissipation member supporting the head substrate, wherein heat from the heating elements is transferred to the heat dissipation member through the head substrate, a surface of the heat dissipation member opposing the head substrate is provided with a heat accumulation adjusting groove which has a recessed shape along the arrangement direction of the row of the heating elements, and both edge portions of the surface of the heat dissipation member in a width direction of the heat accumulation adjusting groove come in contact with a rear surface of the head substrate opposing the heat dissipation member, the width direction being perpendicular to the arrangement direction of the heating elements.

In a thermal head according to an example, the surface of the heat dissipation member is provided with the heat accumulation adjusting groove having a recessed shape along the arrangement direction of the row of the heating elements, so that air in the heat accumulation adjusting groove of the heat dissipation member functions as an insulating material, thereby preventing excessive heat dissipation from the heating element to the heat dissipation member. Also, the heat dissipation member is formed so that both edge portions of the surface of the heat dissipation member in the width direction of the heat accumulation adjusting groove come in contact with the rear surface of the head substrate, so that the head substrate can be stably supported by the heat dissipation member, and heat from the heating elements is transferred to the heat dissipation member from the portions of the surface of the heat dissipation member which come in contact with the head substrate, thereby properly dissipating the heat from the heating element by the heat dissipation member.

In addition, the heat accumulation adjusting groove may be disposed at a position such that a widthwise interval between a center of the heat accumulation adjusting groove in the width direction thereof and a center of the heating element in a width direction thereof is equal to or less than approximately 0.5 mm. Accordingly, a heat accumulation effect can be exhibited by the heat accumulation adjusting groove, thereby further enhancing the power saving effect of the thermal head.

In addition, the heat accumulation adjusting groove may be formed to have a width in the range of approximately 20 to 80% of a width of the head substrate. As described above, the heat accumulation adjusting groove is formed so that the width thereof is equal to or greater than approximately 20% of the width of the head substrate, so that excessive dissipation of the heat from the heating elements by the heat dissipation member can be prevented, thereby further enhancing the power saving effect of the thermal head. Moreover, the heat accumulation adjusting groove is formed so that the width thereof is equal to or smaller than approximately 80% of the width of the head substrate, so that it is possible to obtain a recorded image with good image quality during recording. Furthermore, it is possible to prevent a contact area of the head substrate and the heat dissipation member from being too small, so that it is possible to reliably prevent the head substrate from separating from the heat dissipation member without degrading the shear strength of the head substrate and the heat dissipation member. Therefore, it is possible to stably support the head substrate by the heat dissipation member.

As described above, in the thermal head according to the examples disclosed herein, heat from the heating elements can be properly dissipated by the heat dissipation member, and excessive heat dissipation can be prevented. Accordingly, it is possible to achieve improvements in the heat dissipation characteristics and the power saving effect and stably support the head substrate provided with the heating elements by the heat dissipation member.

### BRIEF DESCRIPTION OF THE DRAWINGS

FIG. 1 is a side view schematically illustrating a thermal head according to an embodiment of the disclosure.

FIG. 2 is a graph showing a relationship between a width of a heat accumulation adjusting groove and a temperature of a heating element in a case where the heat accumulation adjusting groove is disposed at a position such that a center thereof is aligned with a center of the heating element in the thermal head illustrated in FIG. 1.

FIG. 3 is a graph showing a relationship between the width of the heat accumulation adjusting groove and the temperature of the heating element in a case where the heat accumulation adjusting groove is disposed at a position such that a widthwise interval between the center thereof and the center of the heating element is approximately 0.5 mm in the thermal head illustrated in FIG. 1.

FIG. 4 is a graph showing a relationship between the width of the heat accumulation adjusting groove and the temperature of the heating element in a case where the heat accumulation adjusting groove is disposed at a position such that the widthwise interval between the center thereof and the center of the heating element is approximately 1.0 mm in the thermal head illustrated in FIG. 1.

FIG. 5 is a table showing a degree of quality of an image recorded by the thermal head illustrated in FIG. 1.

FIG. 6 is a table showing shear strength of a head substrate and a heat dissipation member of the thermal head illustrated in FIG. 1.

### DESCRIPTION OF EXEMPLARY EMBODIMENTS

The following description is intended to convey a thorough understanding of the embodiments described by providing a number of specific embodiments and details involving thermal heads. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

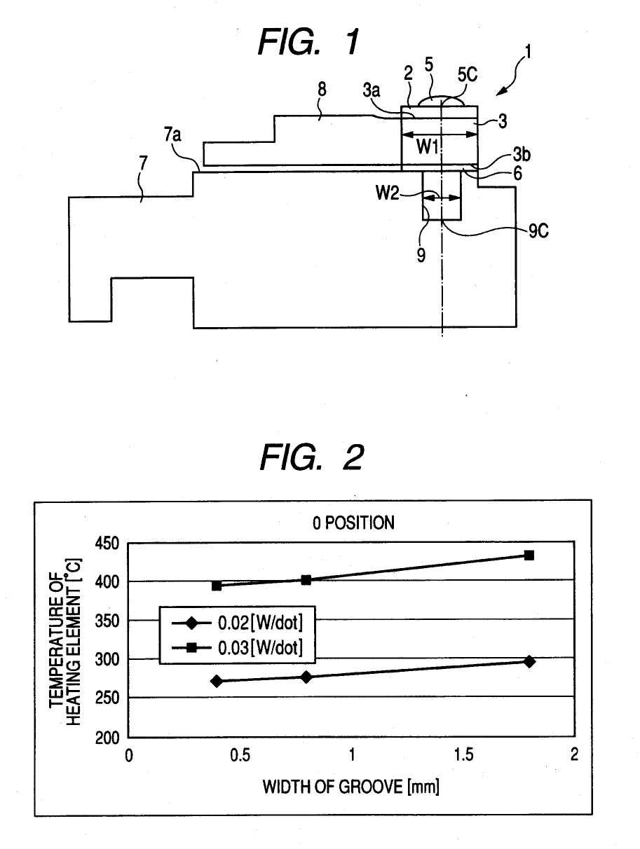

FIG. 1 is a side view schematically illustrating a thermal head 1 according to an exemplary embodiment. As illustrated in FIG. 1, the thermal head 1 according to the embodiment may have a head substrate 3 made of an insulating material or the like such as a ceramic. A plurality of heating elements 5 arranged in a row may be provided on a surface 3a of the head substrate 3 with a heat accumulation glass layer 2, and each heating element 5 may be electrically connected to a printed circuit board 8. The head substrate 3 may be mounted on a surface 7a of a heat dissipation member 7 made of a material having excellent heat dissipation characteristics such as aluminum through an adhesive material 6 made of a silicone resin material or the like. The heat dissipation member 7 may support the head substrate 3 and may dissipate heat from the heating elements 5 so as to achieve an improvement in recording quality.

The surface 7a of the heat dissipation member 7 which may oppose the head substrate 3 may be provided with a heat accumulation adjusting groove 9 which may have a recessed shape in the arrangement direction of the row of the heating elements 5. Accordingly, the heat dissipation member 7 may provide air in the heat accumulation adjusting groove 9 function as an insulating material so as to prevent excessive dissipation of heat from the heating element 5 by the heat dissipation member 7.

In the surface 7a of the heat dissipation member 7, both edge portions in a width direction of the heat accumulation adjusting groove 9 that is perpendicular to the arrangement direction of the heating elements 5 may contact a rear surface 3b of the head substrate 3 opposing the heat dissipation member 7 through the adhesive material 6. Accordingly, the heat dissipation member 7 can stably support the head substrate 3 by both the edge portions in the width direction of the heat accumulation adjusting groove 9. In addition, since both the edge portions in the width direction of the heat accumulation adjusting groove 9 in the surface 7a of the heat dissipation member 7 come in contact with the rear surface 3b of the head substrate 3 through the adhesive material 6, heat from the heating elements 5 may be transferred to the head substrate 3 through the heat accumulation glass layer 2 and then may be transferred to the heat dissipation member 7 from the portions of the surface 7a of the heat dissipation member 7, which may contact the head substrate 3 through the adhesive material 6, it may be possible to properly dissipate the heat from the heating elements 5 to the heat dissipation member 7.

In addition, the thermal head 1 may be disposed to oppose a platen via a recording medium (not shown) or a recording medium and an ink ribbon. The heating elements 5 desired on the basis of recording data input to a printer generate heat, and the thermal head 1 may come in pressing contact with the platen via the recording medium or the recording medium and the ink ribbon, so that ink of the ink ribbon is fused, thereby recording a desired image on the recording medium.

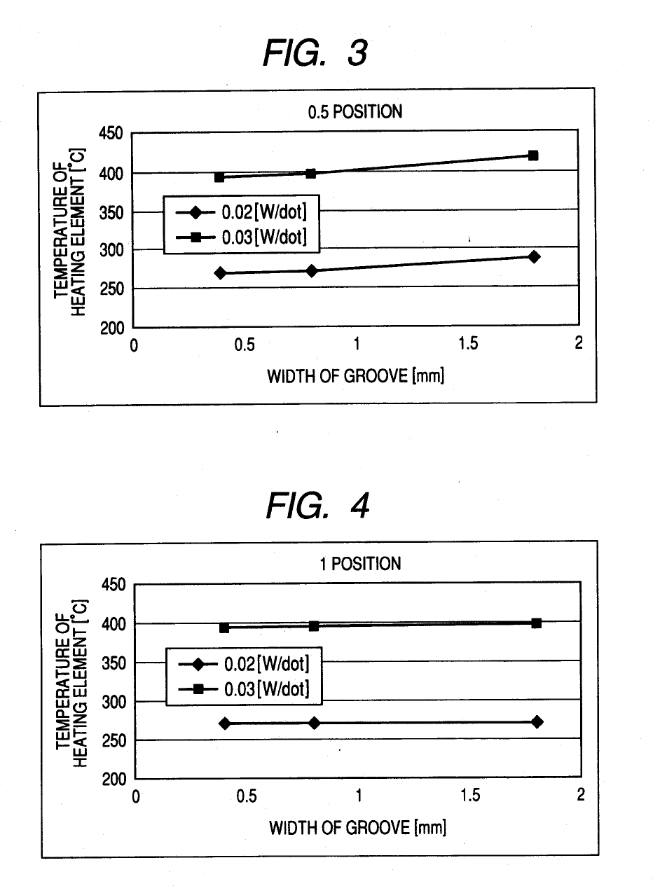

FIGS. 2 to 4 are tables showing relationships between the temperature of the heating element 5 and a width W2 of the heat accumulation adjusting groove 9 in the thermal head 1 illustrated in FIG. 1 in a case where three types of heat dissipation members 7 in which the widths W2 of their heat accumulation adjusting grooves 9 are different may be used and voltages of 0.02 W/dot and 0.03 W/dot are applied to the heating elements 5. Here, a width W1 of the head substrate 3 in the thermal head 1 may be set to approximately 2.44 mm, the width W2 of the heat accumulation adjusting groove 9 may be set to approximately 0.4 mm which may be about 16% of the width W1 of the head substrate 3, approximately 0.8 mm which may be about 33% thereof, and approximately 1.8 mm which may be about 74% thereof. In addition, FIG. 2 shows a case where the heat accumulation adjusting groove 9 is disposed at a position such that a center 9C of the heat accumulation adjusting groove 9 in the width direction thereof in the thermal head 1 under the above-mentioned condition is aligned in the width direction with a center 5C of the heating element 5 in the width direction thereof. FIG. 3 shows a case where the heat accumulation adjusting groove 9 is disposed so that the center 9C of the heat accumulation adjusting groove 9 is distant from the center 5C of the heating element 5 by 0.5 mm in the width direction. FIG. 4 shows a case where the heat accumulation adjusting groove 9 is disposed so that the center 9C of the heat accumulation adjusting groove 9 is distant from the center 5C of the heating element 5 by approximately 1.0 mm in the width direction.

Here, as shown in FIGS. 2 and 3, in the case where the heat accumulation adjusting groove 9 is disposed so that the center 9C of the heat accumulation adjusting groove 9 and the center 5C of the heating element 5 may be aligned with each other, and in the case where the heat accumulation adjusting groove 9 is disposed so that the center 9C of the heat accumulation adjusting groove 9 is distant from the center 5C of the heating element 5 by approximately 0.5 mm in the width direction, even when a voltage of 0.02 W/dot or a voltage of 0.03 W/dot is applied to the heating element 5, the temperature of the heating element 5 may increase as the width of the heat accumulation adjusting groove 9 increases. However, as illustrated in FIG. 4, in the case where the heat accumulation adjusting groove 9 is disposed so that the center 9C of the heat accumulation adjusting groove 9 is distant from the center portion 5C of the heating element 5 by approximately 1.0 mm in the width direction and the two levels of voltage are applied to the heating element 5, the temperature of the heating element 5 may hardly change even though the width W2 of the heat accumulation adjusting groove 9 increases, so that it can be seen that the temperature of the heating element 5 is hardly affected by the width W2 of the heat accumulation adjusting groove 9. From this, it can be seen that when the heat accumulation adjusting groove 9 may be disposed so that the center 9C of the heat accumulation adjusting groove 9 is distant from the center 5C of the heating element 5 by approximately 0.5 mm or further in the width direction in the thermal head 1, the heat accumulation effect of the heat accumulation adjusting groove 9 which may be exhibited as the air in the heat accumulation adjusting groove 9 functions as an insulating material rarely occurs, and the heat from the heating element 5 is dissipated by the heat dissipation member 7 via the head substrate 3. As a result, a power saving effect of the thermal head 1 rarely occurs.

Therefore, from the results shown in FIGS. 2 to 4, the heat accumulation adjusting groove 9 may be disposed at a position such that the widthwise interval between the center 9C of the heat accumulation adjusting groove 9 and the center 5C of the heating element 5 is equal to or less than approximately 0.5 mm.

In addition, as illustrated in FIGS. 2 to 4, it can be seen that since the temperature of the heating element 5 increases as the width W2 of the heat accumulation adjusting groove 9 increases when the width W2 of the heat accumulation adjusting groove 9 is between approximately 0.4 mm that is about 10% of the width W1 of the head substrate 3 and approximately 1.8 mm that is about 74% thereof, the power saving effect can be obtained. In addition, in the graphs shown in FIGS. 2 to 4, the relationship between the width W2 of the heat accumulation adjusting groove 9 and the temperature of the heating element 5 may have a gradient of a quadratic function. Accordingly, in FIGS. 2 to 4, the relationship between the width W2 of the heat accumulation adjusting groove 9 and the temperature of the heating element 5 in the case where the width W2 of the heat accumulation adjusting groove 9 may be 0, has substantially the same result as that of the case where the width W2 of the heat accumulation adjusting groove 9 is approximately 16% of the width W1 of the head substrate 3, that is, approximately 0.4 mm which is shorter than 20%. Namely, it can be seen that in the case where the width W2 of the heat accumulation adjusting groove 9 is smaller than 20% of the width W1 of the head substrate 3, the temperature of the heating element 5 is hardly affected by the degree of the width W2 of the heat accumulation adjusting groove 9, so that the air in the heat accumulation adjusting groove 9 hardly functions as an insulating material. From this, it can be seen that when the width W2 of the heat accumulation adjusting groove 9 in the thermal head 1 is set to be smaller than approximately 20% of the width W1 of the head substrate 3, the heat accumulation effect of the heat accumulation adjusting groove 9 hardly occurs, and the heat from the heating element 5 may be dissipated by the heat dissipation member 7 through the head substrate 3, and as a result, the power saving effect of the thermal head 1 rarely occurs.

Therefore, from the results of FIGS. 2 to 4, the heat accumulation adjusting groove 9 may be formed so that the width W2 of the heat accumulation adjusting groove 9 is equal to or greater than approximately 20% of the width W1 of the head substrate 3.

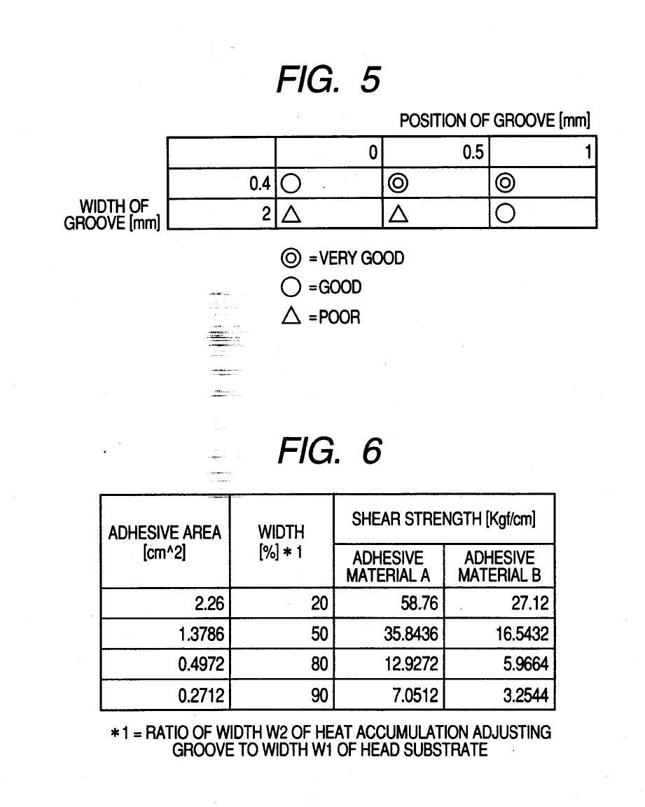

FIG. 5 is a table showing the image quality of recorded images obtained by performing recording using two types of heat dissipation member 7 in which the widths W2 of the heat accumulation adjusting grooves 9 are different at different dispositions of the heat accumulation adjusting grooves 9 in the thermal head 1 illustrated in FIG. 1. Here, as an example, the width W1 of the head substrate 3 in the thermal head 1 used for inspecting the image quality was set to approximately 2.44 mm, and the widths W2 of the heat accumulation adjusting grooves 9 were set to approximately 0.4 mm that is about 16% of the width W1 of the head substrate 3 and approximately 2.0 mm that is about 82% thereof. In addition, the heat accumulation adjusting grooves 9 were disposed at the position where the center 9C of the heat accumulation adjusting groove 9 is aligned with the center 5C of the heating element 5 in the width direction, the position where the center 9C of the heat accumulation adjusting groove 9 is distant from the center 5C of the heating element 5 by 0.5 mm in the width direction, and the position where the center 9C of the heat accumulation adjusting groove 9 is distant from the center 5C of the heating element 5 by 1.0 mm in the width direction. Furthermore, image quality was determined by comparing degrees of printing tailing with a reference image recorded under a maximum condition (for example, at an optical density of 2.3) of product specification.

As illustrated in FIG. 5, in the case where the width W2 of the heat accumulation adjusting groove 9 was approximately 0.4 mm and the heat accumulation adjusting groove 9 was disposed so that the center 9C of the heat accumulation adjusting groove 9 is aligned with the center 5C of the heating element 5 in the width direction, image quality was good. In the case where the heat accumulation adjusting groove 9 was disposed so that the center 9C of the heat accumulation adjusting groove 9 is distant from the center 5C of the heating element 5 by approximately 0.5 or 1.0 mm in the width direction, image quality was very good. In the case where the heat accumulation adjusting groove 9 was disposed so that the width W2 of the heat accumulation adjusting groove 9 is approximately 2.0 mm and the center 9C of the heat accumulation adjusting groove 9 is distant from the center 5C of the heating element 5 by approximately 1.0 mm in the width direction, image quality was good. In the case where the heat accumulation adjusting groove 9 was disposed so that the width W2 of the heat accumulation adjusting groove 9 is approximately 2.0 mm and the center 9C of the heat accumulation adjusting groove 9 is aligned with the center 5C of the heating element 5 in the width direction or the center 9C of the heat accumulation adjusting groove 9 is distant from the center 5C of the heating element 5 by approximately 0.5 mm in the width direction, image quality was poor as compared with the reference image. From this, it could be seen that when the width W2 of the heat accumulation adjusting groove 9 is greater than 80% of the width W1 of the head substrate 3, a heat accumulated state is caused due to the deterioration of the heat dissipation, so that image quality of the recorded image may be degraded.

FIG. 6 is a table showing shear strength (Kgf/cm) of the head substrate 3 and the heat dissipation member 7 in the case where the head substrate 3 is adhered to four types of heat dissipation member 7 in which the widths W2 of the heat accumulation adjusting grooves 9 are different using two types of adhesive material 6 in the thermal head 1 illustrated in FIG. 1. Here, the width W1 of the head substrate 3 in the thermal head 1 used for inspecting the shear strength was set to approximately 2.44 mm, the length thereof was set to approximately 113 mm, and the widths W2 of the heat accumulation adjusting grooves 9 were set to 20%, 50%, 80%, and 90% of the width W1 of the head substrate 3. As the adhesive material 6, two types of silicone adhesive material having different thermal conductivities and viscosities, that is, an adhesive material 6A and an adhesive material 6B were used. In addition, the entire rear surface 3b of the head substrate 3 opposing the heat dissipation member 7 except for the position thereof opposing the heat accumulation adjusting groove 9 was in a state adhered to the heat dissipation member 7 through the adhesive material 6.

As shown in FIG. 6, in the case where the width W2 of the heat accumulation adjusting groove 9 is equal to or smaller than approximately 80% of the width W1 of the head substrate 3, the shear strength was equal to or higher than 5 Kgf/cm. However, when the adhesive material 6B was used when the width W2 of the heat accumulation adjusting groove 9 was 90% of the width W1 of the head substrate 3, the shear strength of the head substrate 3 and the heat dissipation member 7 was 3.25 Kgf/cm, and for example, when a shear strength reference value needed for adhering the head substrate 3 to the heat dissipation member 7 is set to 5 Kgf/cm, the shear strength is equal to or less than the reference value. From this, there was a concern that in the case where the width W2 of the heat accumulation adjusting groove 9 in the thermal head 1 is greater than approximately 80% of the width W1 of the head substrate 3, the head substrate 3 may be separated from the heat dissipation member 7.

Therefore, from the results shown in FIGS. 5 and 6, the heat accumulation adjusting groove 9 may be formed so that the width W2 of the heat accumulation adjusting groove 9 is equal to or smaller than 80% of the width W1 of the head substrate 3.

As a result, in the thermal head 1 according to this embodiment, the heat accumulation adjusting groove 9 may be disposed in a position such that the widthwise interval between the center 9C of the heat accumulation adjusting groove 9 and the center 5C of the heating element 5 is equal to or less than approximately 0.5 mm, and the width W2 of the heat accumulation adjusting groove 9 may be in the range of 20 to 80% of the width W1 of the head substrate 3.

Next, operations of the thermal head 1 according to various embodiments will be described.

The surface 7a of the heat dissipation member 7 may be provided with the heat accumulation adjusting groove 9 having a recessed shape along the arrangement direction of the row of the heating elements 5, and the heat accumulation adjusting groove 9 may be disposed at a position such that both the edge portions of the surface 7a of the heat dissipation member 7 in the width direction of the heat accumulation adjusting groove 9 come in contact with the rear surface 3b of the head substrate 3 opposing the heat dissipation member 7. Accordingly, the thermal head 1 may provide air in the heat accumulation adjusting groove 9 of the heat dissipation member 7 function as an insulating material thereby preventing excessive heat dissipation from the heating element 5 to the heat dissipation member 7. In addition, the thermal head 1 can stably support the head substrate 3 by both the edge portions of the surface 7a of the heat dissipation member 7 in the width direction of the heat accumulation adjusting groove 9. Furthermore, since heat from the heating element 5 may be transferred to the head substrate 3 through the heat accumulation glass layer 2 and then transferred from the portions of the substrate 7a of the heat dissipation member 7 that come in contact with the head substrate 3 through the adhesive material 6 to the heat dissipation member 7, the heat from the heating element 5 may be properly dissipated by the heat dissipation member 7 in the thermal head 1.

Therefore, the thermal head 1 according to these embodiments properly dissipates the heat from the heating element 5 using the heat dissipation member 7 and simultaneously prevents the excessive heat dissipation, thereby achieving the improvement in the heat dissipation characteristics and the power saving effect. In addition, the thermal head 1 can stably support the head substrate 3 provided with the heating element 5 by the heat dissipation member 7.

In addition, the heat accumulation adjusting groove 9 may be disposed at a position such that the widthwise interval between the center 9C of the heat accumulation adjusting groove 9 and the center 5C of the heating element 5 is equal to or less than approximately 0.5 mm, so that the air in the heat accumulation adjusting groove 9 can effectively function as the insulating material. Accordingly, the heat accumulation effect can be exhibited by the heat accumulation adjusting groove 9, so that the power saving effect of the thermal head 1 can further be improved.

In addition, the heat accumulation adjusting groove 9 is formed so that the width W2 thereof is equal to or greater than approximately 20% of the width W1 of the head substrate 3, so that excessive dissipation of the heat from the heating elements 5 by the heat dissipation member 7 can be prevented, thereby further enhancing the power saving effect of the thermal head 1.

In addition, the heat accumulation adjusting groove 9 may be formed so that the width W2 thereof is equal to or less than approximately 80% of the width W1 of the head substrate 3, so that it may be possible to prevent image quality degradation of an image recorded by using the thermal head 1. Furthermore, it may be possible to prevent a contact area of the head substrate 3 and the heat dissipation member 7 from being too small, so that it may be possible to reliably prevent the head substrate 3 from separating from the heat dissipation member 7 without degrading the shear strength of the head substrate 3 and the heat dissipation member 7. Therefore, it may be possible to stably support the head substrate 3 by the heat dissipation member 7.

In addition, the invention is not limited by the embodiments, and various modifications can be made as needed.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. A thermal head comprising:
a head substrate including a plurality of heating elements arranged in a row; and
a heat dissipation member supporting the head substrate, the heat dissipation member having edge portions,
wherein heat from the heating elements is transferred to the heat dissipation member through the head substrate,
a surface of the heat dissipation member opposing the head substrate is provided with a heat accumulation adjusting groove which has a recessed shape along the arrangement direction of the row of the heating elements, and
the edge portions of the surface of the heat dissipation member in a width direction of the heat accumulation adjusting groove come in contact with a rear surface of the head substrate opposing the heat dissipation member, the width direction being perpendicular to the arrangement direction of the heating elements.

2. The thermal head according to claim 1, wherein the heat accumulation adjusting groove is disposed at a position such that a widthwise interval between a center of the heat accumulation adjusting groove in the width direction thereof and a center of the heating element in a width direction thereof is equal to or less than 0.5 mm.

3. The thermal head according to claim 1, wherein the heat accumulation adjusting groove is formed to have a width in the range of 20 to 80% of a width of the head substrate.
